(19) United States
(12) Patent Application Publication
(10) Pub. No.: US 2005/0253094 A1
(43) Pub. Date: Nov. 17, 2005

(54) Optical encoder and alignment jig

(76) Inventors: Theng Hooi Yeoh, Penang (MY); Siow Ming Tan, Pulau Pinang (MY); Teng Siew Tan, Penang (MY); Moon Leong Low, Penang (MY); Ewe Aik Oo, Penang (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/843,820

(22) Filed: May 12, 2004

(51) Int. Cl. G01V 8/00; G01D 5/34

(52) U.S. Cl. 250/559.3; 250/231.13

(57) ABSTRACT

Alignment of an optical encoder with respect to a codewheel. An alignment jig is used to align the encoder with respect to the codewheel shaft by mating with the codewheel shaft and with reference features on the encoder, which may comprise pins or receiving means for pins. One or more of the pins may be tapered to speed assembly.

### TECHNICAL FIELD

Embodiments in accordance with the invention relate generally to optical encoders and more particularly to rotary optical encoders Still more particularly, embodiments in accordance with the invention relate to alignment of optical encoders with respect to code wheels.

### BACKGROUND

An encoder is a motion detector which provides feedback to a motor control system. A typical encoder design consists of an emitter/detector module operating in a transmissive, reflective, or imaging configuration. When operated in conjunction with a codewheel, the encoder translates rotary motion into a digital output.

As the resolution of the detector increases, so do the requirements for proper alignment of the encoder with respect to the codewheel.

### SUMMARY

In accordance with the invention, an optical encoder adapted for use with an alignment jig is provided. The alignment jig mates with the shaft holding the codewheel. The alignment jig has reference features which mate with matching features in the optical encoder, providing proper radial and tangential alignment of the encoder with respect to the codewheel shaft.

### BRIEF DESCRIPTION OF THE DRAWINGS

The invention will best be understood by reference to the following detailed description of embodiments in accordance with the invention when read in conjunction with the accompanying drawings, wherein:

FIG. 1 shows a transmissive optical encoder known to the art,

FIG. 2 shows a reflective optical encoder known to the art,

FIG. 3 shows an imaging optical encoder known to the art,

FIG. 4 is a side view of an encoder and codewheel,

FIG. 5 is a diagram of mounting errors, and

FIG. 6 shows an encoder, codewheel, and alignment jig.

### DETAILED DESCRIPTION

The invention relates to optical encoders, and the alignment of rotary optical encoders with respect to codewheels. The following description is presented to enable one skilled in the art to make and use the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments show but is to be accorded the widest scope consistent with the appended claims and with the principles and features described herein.

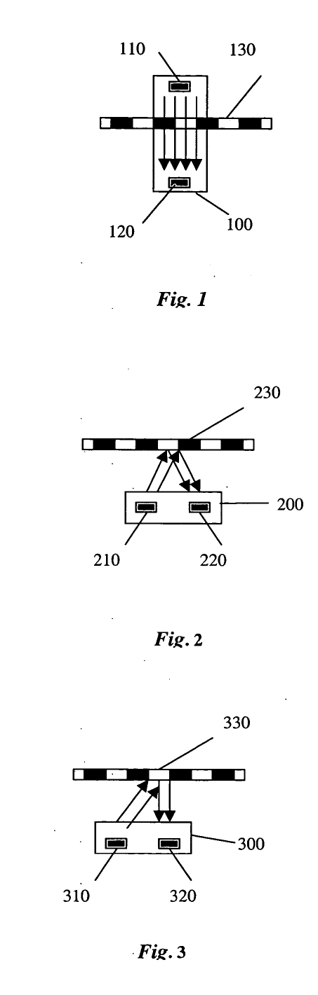

With reference now to the figures and in particular with reference to FIGS. 1 through 3, representative optical encoders for use with the invention are shown.

In the transmissive type of encoder shown in FIG. 1, encoder 100 consists of light source 110 and detector 120. Codewheel 130 containing a pattern of transparent and opaque regions interrupts the light passing from source 110 to detector 120. Various technologies may be used in this type of encoder. Source 110 may be any light emitter, such as an incandescent bulb, although a light emitting diode is preferred. A laser diode may also be used. Detector 120 is preferably a photodiode, although other technologies such as photocells or photoresistive elements may also be used. Codewheel 130 may be a transparent material such as plastic or glass with opaque regions placed on it, or may be an opaque material such as a metal disc with holes placed in it to allow the passage of light.

FIG. 2 shows a reflective encoder 200, with source 210 and detector 220. Codewheel 230 reflects light from source 210 to detector 220. Technology tradeoffs for source 210 and detector 220 are similar to those in transmissive type encoders. Codewheel 230 contains regions which reflect light from source 210 to detector 220, and regions which do not reflect light from source 210 to detector 220. This reflection need not be in the nature of a focused or sharp reflection; it is usually in the nature of a specular reflection. Codewheel 230 may be made of a nonreflective material with reflective elements, or it may be made of a reflective material with masked nonreflective areas.

FIG. 3 shows an imaging encoder. In the imaging encoder, emitter 310 and codewheel 330 are similar to those used in reflective encoders such as shown in FIG. 2. In the imaging encoder, an imaging array 320 is used rather than a simple photodetector such as used in simpler transmissive and reflective encoder designs.

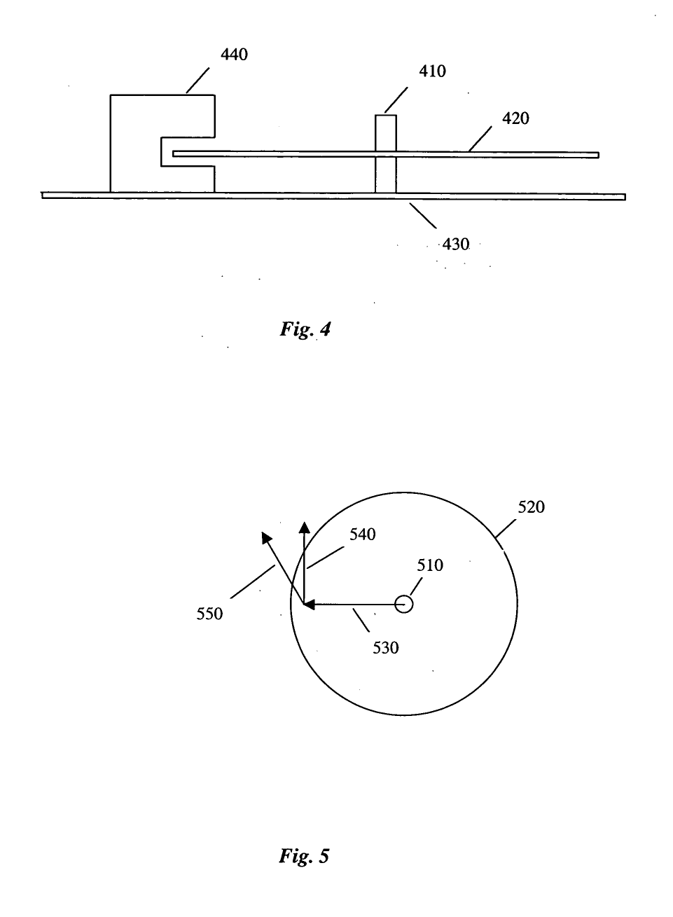

FIG. 4 shows a side view of an encoder and codewheel. Shaft 410 supports codewheel 420. Shaft 410 is rotatably mounted to base 430, usually through use of a bearing, not shown. Encoder 440 is also mounted to base 430. The alignment of encoder 440 to codewheel 420 is of vital importance to the proper operation of encoder 440. As the resolution of codewheel 420 and encoder 440 increase, this alignment becomes more important.

FIG. 5 is a diagram of two important mounting errors. Shaft 510 supports codewheel 520. Ideally, an encoder will be positioned at a particular radial distance 530 from the center of the shaft. The encoder should also be tangential 540 to this radial line 540. A grossly exaggerated tangential error is shown as line 550. The two errors important to the instant invention are radial error and tangential error.

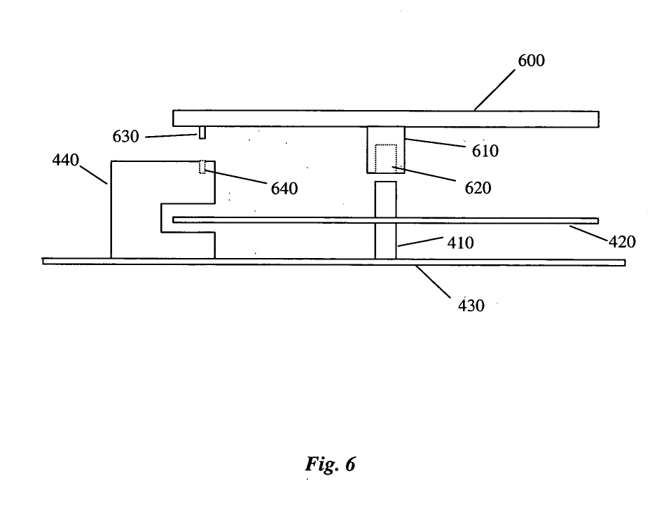

According to the present invention, and shown in FIG. 6, alignment jig 600 includes central post 610 with recess 620 for receiving shaft 410. When alignment jig 600 is lowered, and shaft 410 engages with recess 620 in post 610, alignment post 630 on alignment jig 600 engages alignment recess 640 in encoder 440. In the preferred embodiment, alignment post 630 is matched by an additional post, not shown, at the same radial distance as post 630. While more than two matching alignment posts and recesses may be used, two post-recess pairs have been found suitable to provide the needed alignment.

With the alignment posts on alignment jig 600 engaged in the corresponding alignment recesses in encoder 440, encoder 440 is held in precise radial and tangential alignment to shaft 410. While this alignment is provided by the use of alignment jig 600, encoder 440 may be fixed in position to base 430. This fixing may be made through the use of fasteners such as screws, through adhesives including but not limited to cyanoacrylates or epoxies, or combinations. As an example, screws could be used to hold encoder 440 in place on base 430 while an adhesive sets.

While in the preferred embodiment posts are present on alignment jig 600 which mate with recesses in the encoder, posts may be provided on the encoder, and the recesses on the alignment jig. One post may be provided on the alignment jig, and one may be provided on the encoder.

To assist in positioning, a portion of the alignment pins may be tapered. Additionally, recess 620 on alignment shaft 610 may be flared to ease its engagement with shaft 410. Flaring may also be used on the alignment recesses in encoder 440. The use of tapering on pins and flaring on recesses may aid in the ease of engaging alignment jig 600 with shaft 410 and encoder 440.

The foregoing detailed description of the present invention is provided for the purpose of illustration and is not intended to be exhaustive or to limit the invention to the precise embodiments disclosed. Accordingly the scope of the present invention is defined by the appended claims.

1. The method of aligning an optical encoder to a codewheel mounted on a shaft, the method comprising:
engaging a first alignment means on an alignment jig with the shaft, and
engaging a second alignment means on the alignment jig with a corresponding alignment means on the optical encoder to align the optical encoder with respect to the shaft.

2. The method of claim 1 where the second alignment means on the alignment jig comprises a plurality of pins.

3. The method of claim 2 where at least a portion of one of the plurality of pins is tapered.

4. The method of claim 1 where the alignment means on the optical encoder comprises a plurality of pins.

5. The method of claim 4 where at least a portion of one of the plurality of pins is tapered.

6. The method of aligning an optical encoder to a codewheel mounted on a shaft, the codewheel mounted rotatably to a base, the method comprising:
engaging a first alignment means on an alignment jig with the shaft,
engaging a second alignment means on the alignment jig with a corresponding alignment means on the optical encoder to align the optical encoder with respect to the shaft, and
fixing the optical encoder to the base, preserving the alignment of the optical encoder with respect to the base.

7. The method of claim 6 where the optical encoder is fixed to the base using an adhesive.

8. The method of claim 6 where the optical encoder is fixed to the base using screws.

9. The method of claim 6 where the second alignment means on the alignment jig comprises a plurality of pins.

10. The method of claim 9 where at least a portion of one of the plurality of pins is tapered.

11. The method of claim 6 where the alignment means on the optical encoder comprises a plurality of pins.

12. The method of claim 11 where at least a portion of one of the plurality of pins is tapered.
